(19) United States
(12) Patent Application Publication
(10) Pub. No.: US 2008/0014524 A1
(43) Pub. Date: Jan. 17, 2008

(54) DEVELOPING AGENT AND IMAGE FORMING METHOD

(75) Inventor: Shoko Shimmura, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/456,711

(22) Filed: Jul. 11, 2006

(51) Int. Cl. G03G 15/08; G03G 9/08; G03G 15/01; G03G 15/09

(52) U.S. Cl. 430/111.41; 399/267; 399/302

(57) ABSTRACT

The invention defines an adhesive force characteristic of a toner, which makes it possible to control behaviors of toner particles by applying an electric field, and defines, when an amount of charges before transfer per weight of the toner particles is Q (μC/g), an average adhesive force of the toner particles to the medium is F (N), a volume average particle diameter of the toner particles is d (μm), and a specific gravity of the toner particles is ρ (g/cm³), an A value represented by A=(K×Q+F₀/Q)×6/ρπd³) (K: an inclination at the time when F is approximated to a linear function of Q², F₀: a y intercept at the time when F is approximated to a linear function of Q²) in a range of 1×10⁷≦A≦2.5×10⁷ (N/C). Consequently, a developing agent has a highly efficient and stable transfer characteristic and it is possible to form a high-quality image.

### BACKGROUND OF THE INVENTION

1. Field of the Invention

The present invention relates to a developing agent and an image forming method used in forming an image in an electrophotographic system of, for example, a copying machine and a printer.

2. Description of the Related Art

In general, in an image forming apparatus using the electrophotographic system, a toner is carried through carrying media like an electrostatic latent image bearing member such as a photosensitive member and an intermediate transfer medium such as a transfer belt and adhered in a desired position on a transfer medium such as paper. Then, the toner is compression-bonded by a heat roller or the like to be fixed on the transfer medium, whereby an image is formed on the transfer medium.

In this case, the toner is attached on these carrying media by an electrostatic force, a Van der Waals force, and a liquid bridging force based on an amount of charges held by toner particles. The toner attached is peeled from a medium mainly by an external electric field and attached on the next carrying medium. The toner attached on and peeled from the carrying media and carried is finally fixed on the transfer medium. Therefore, it is necessary to control an adhesive force of the toner to the media in order to efficiently carry the toner and finally form a high-quality image.

In recent years, a toner particle diameter tends to be reduced in order to realize high definition of images. As the toner particle diameter becomes smaller, an amount of charges held by one toner particle decreases. Thus, a force of an electric field is less easily applied and an adhesive force decreases. Therefore, the toner easily scatters from the electrostatic latent image bearing member. The transfer efficiency is deteriorated and contamination inside the apparatus and of images is caused.

In recent years, there is a tendency of not providing a cleaner in an image forming apparatus (cleanerless). A cleanerless process is a process for electrostatically controlling an adhesive force and collecting toner particles on an electrostatic latent image bearing member simultaneously with development without using a cleaner. In the cleanerless process, there is a problem in that exposure is hindered by an influence of a transfer residual toner because of control failure of the adhesive force and a negative image memory occurs. If such a cleanerless process is applied in a full-color image forming apparatus that uses four kinds of toners of yellow, magenta, cyan, and black, toner particles may be inversely transferred onto the electrostatic latent image bearing member because of the control failure of the adhesive force. Since mixture of toner particles of different colors occurs at the time of collection, discoloration is caused.

Conventionally, various methods of controlling an adhesive force have been proposed. For example, in JP-A-2004-101753, a method of holding down variation of transfer characteristics by controlling an average adhesive force and a standard deviation of an adhesive force distribution measured under specific conditions is proposed. However, there is a problem in that strict control is required in a manufacturing process in order to hold down the standard deviation of the adhesive force distribution. The standard deviation is tolerated to a certain extent by increasing the average adhesive force. However, if the adhesive force is high, since it is necessary to also increase the external electric field for transferring the toner to the transfer medium, it is likely that aerial discharge is caused. Moreover, in the measurement under the conditions disclosed, behaviors of a small quantity of particles having an extremely large adhesive force and particles having an extremely small adhesive force are not reflected on an evaluation of only the average adhesive force and the standard deviation. Therefore, it is difficult to hold down a transfer residue due to large particles and toner scattering around an image due to smaller particles and obtain a high-quality image.

### SUMMARY OF THE INVENTION

It is an object of the invention to provide a developing agent and an image forming method that define an adhesive force characteristic of a toner, which makes it possible to control behaviors of toner particles by applying an electric field, have a highly efficient and stable transfer characteristic, and are capable of obtaining a high-quality image.

According to an aspect of the invention, there is provided a developing agent including toner particles containing a colorant and resin, the toner particles carried and transferred to a medium using an electrostatic force generated by an electric field, and wherein an amount of charges before transfer per weight of the toner particles is Q (μC/g), an average adhesive force of the toner particles to the medium is F (N), a volume average particle diameter of the toner particles is d (μm), and a specific gravity of the toner particles is ρ (g/cm³), an A value represented by
A=(K×Q+F₀/Q)×6/ρπd³
K: an inclination at the time when F is approximated to a linear function of Q²
F₀: a y intercept at the time when F is approximated to a linear function of Q²
   is in a range of
   1×10⁷≦A≦2.5×10⁷(N/C).

According to an aspect of the invention, there is provided an image forming method including carrying and transferring toner particles containing a colorant and resin to a medium using an electrostatic force generated by an electric field E (V/m), and wherein the electric field E is
1×10⁷≦E≦2.5×10⁷(V/m) and,
an amount of charges before transfer per weight of the toner particles is Q (μC/g), an average adhesive force of the toner particles to the medium is F (N), a volume average particle diameter of the toner particles is d (μm), and a specific gravity of the toner particles is ρ (g/cm³), has a relation of
0.9≦E/A<1.1
with respect to an A value represented by
A=(K×Q+F₀/Q)×6/ρπd³
K: an inclination at the time when F is approximated to a linear function of Q²
F₀: a y intercept at the time when F is approximated to a linear function of Q².

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE DRAWINGS

FIG. 1 is a perspective view showing a sample set for measuring an average attach quantity of toner particles in an aspect of the invention;

FIG. 2 is a sectional view showing a cell for measuring an average attach quantity of toner particles in the aspect of the invention;

FIG. 3A is a perspective view showing an angle rotor for measuring an average attach quantity of toner particles in the aspect of the invention;

FIG. 3B is a sectional view showing an angle rotor for measuring an average attach quantity of toner particles in the aspect of the invention;

FIG. 4 is a conceptual diagram showing an image forming apparatus according to a two-component development process in the aspect of the invention;

FIG. 5 is a conceptual diagram showing an image forming apparatus according to a cleanerless process in the aspect of the invention;

FIG. 6 is a conceptual diagram showing an image forming apparatus according to a 4-drum tandem process in the aspect of the invention;

FIG. 7 is a conceptual diagram showing an image forming apparatus according to a 4-drum tandem process provided with an intermediate transfer medium in the aspect of the invention;

FIG. 8 is a table showing a result of a K value and F₀ of toner particles in the aspect of the invention; and

FIG. 9 is a diagram showing a relation between an A value and an amount of charges Q of toner particles in the aspect of the invention.

### DETAILED DESCRIPTION OF THE EMBODIMENTS

A developing agent according to an aspect of the invention is characterized by including toner particles containing a colorant and resin, the toner particles carried and transferred to a medium using an electrostatic force generated by an electric field, and wherein an amount of charges before transfer per weight of the toner particles is Q (μC/g), an average adhesive force of the toner particles to the medium is F (N), a volume average particle diameter of the toner particles is d (μm), and a specific gravity of the toner particles is ρ (g/cm³), an A value represented by
A=(K×Q+F₀/Q)×6/ρπd³
K: an inclination at the time when F is approximated to a linear function of Q²
F₀: a y intercept at the time when F is approximated to a linear function of Q²
   is in a range of
   1×10⁷≦A≦2.5×10⁷(N/C)

The toner particles are formed of at least binder resin such as polyester resin or styrene-acrylic resin and a colorant such as a publicly-known pigment or dye like carbon black, condensation polycyclic pigment, azo pigment, phthalocyanine pigment, or inorganic pigment. The toner particles are formed by a grinding method or a chemical process using a publicly-known composition like a fixing aid agent such as a wax, a charge control agent(CCA), and inorganic particulates such as silica, alumina, or titanium oxide or organic particulates with an object of improvement of fluidity. It is desirable that a volume average particle diameter d of such toner particles is 3 to 7 μm. If the volume average particle diameter d is smaller than 3 atm, when an amount of charges that can be controlled by an electric field is given to the respective toner particles, an amount of charges per weight becomes excessively large to make it difficult to obtain a desired development amount. If the volume average particle diameter d is larger than 7 μm, reproducibility and graininess of a fine image are deteriorated. More preferably, the volume average particle diameter d is 4 to 6 μm.

In the case of two-component development, a two-component developing agent further added with a magnetic carrier is used. The magnetic carrier is formed of resin particles mixed with magnetic powder of ferrite, magnetite, or iron oxide or particles obtained by applying resin coat to at least a part of surfaces of magnetic powder or the like. It is desirable that a volume average particle diameter of such magnetic carrier particles is 20 to 100 μm. If the volume average particle diameter is smaller than 20 μm, since a magnetic force of one particle is small, the magnetic carrier particles easily separate from a developing agent bearing member to adhere to an image bearing member (carrier deposition). If the volume average particle diameter is larger than 100 μm, a magnetic brush hardens and brushing traces of the brush appear in an image or precise toner supply cannot be performed. Preferably, the volume average particle diameter is 35 to 60 μm.

The medium indicates any one of an electrostatic latent image bearing member such as a photosensitive member, a conveyance medium such as an intermediate medium like a belt or a roller, and a final transfer medium such as paper.

It is desirable that the amount of charges before transfer Q(μC/g) of the toner is −20 to −80 μC/g. If the amount of charges is smaller than −20 μC/g, it is difficult to perform control by an electric field in, in particular, a small particle diameter toner. Thus, a problem occurs in that, for example, the toner scatters to the outside of the developing device because of a centrifugal force due to rotation of the electrostatic latent image bearing member or a non-image portion on the electrostatic latent image bearing member is soiled. If the amount of charges is equal to or larger than −80 μC/g, it is difficult to supply a sufficient amount of toner to a latent image in a development area. Thus a problem occurs in that a high density image is not obtained.

When it is necessary to perform more accurate control of an adhesive force, for example, when the cleanerless process is applied to the 4-drum tandem process used in the full-color image forming apparatus, it is necessary to control an amount of charges to be in a narrower range. It is desirable that the amount of charges before transfer is in a range of −70≦Q≦−40 (μC/g).

The average adhesive force F (N) of the toner particles to the medium is measured as described below using an ultracentrifuge for separation (CP100MX) manufactured by Hitachi Koki Co., Ltd., an angle rotor (P100AT2), and a cell manufactured for measuring a powder adhesive force.

(A Method of Measuring the Average Adhesive Force F (N))

(1) A sheet having a surface protective layer equivalent to a carrying medium, an adhesive force of which is measured, formed on a surface thereof is manufactured. For example, when an adhesive force to a photosensitive member is measured, a photosensitive member sheet is manufactured. When an adhesive force to an intermediate transfer belt is measured, a sheet equivalent to a belt material is manufactured. In order to measure an adhesive force, a surface protective layer needs to be equivalent to a carrying medium, an adhesive force of which is measured. In measurement of a toner adhesive force to a photosensitive member, as in the photosensitive member, a charge generation layer (CGL) and a charge transport layer (CTL) may be laminated. This sheet is wound around an aluminum element pipe to ground a photosensitive layer and placed in a photosensitive drum position. The toner is developed/attached to the surface thereof in the same manner as usual image formation. In measurement of a toner adhesive force to the intermediate transfer belt, the toner may be transferred from a usual photosensitive member to a sheet equivalent to the intermediate transfer belt, or the belt material an adhesive force of which is measured,.

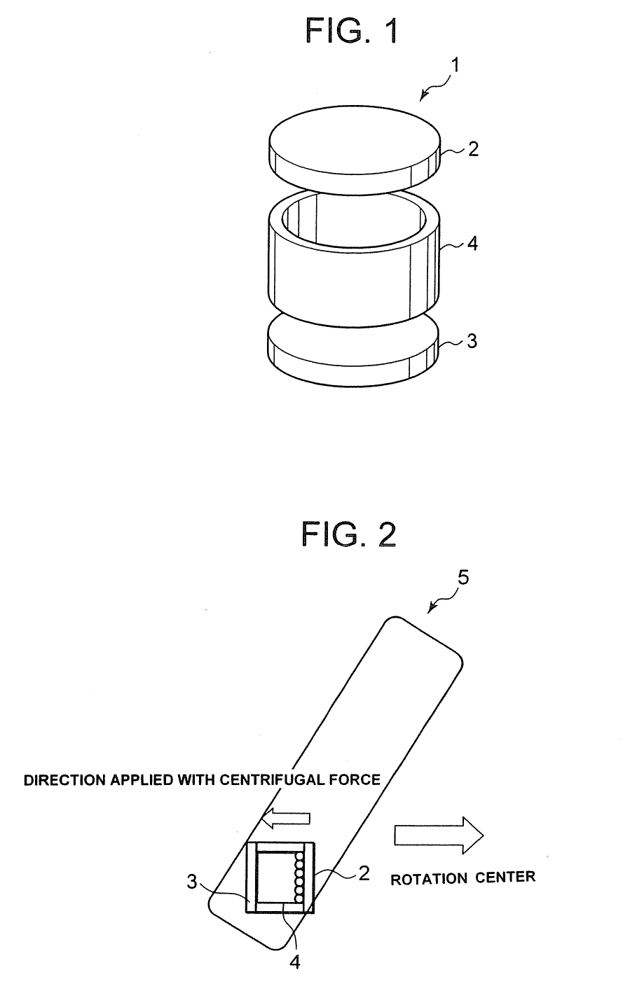

(2) The sheet attached with the toner is placed in a sample set. As shown in FIG. 1, a sample set 1 includes a plate A 2, a plate B 3, and a cylindrical spacer 4. An outer peripheral diameter of the plate A 2, the plate B3, and the spacer 4 is 7 mm, thickness of the spacer 4 is 1 mm, and height of the space 4 is 3 mm. The sheet attached with the toner is cut into a size of the plate A and stuck to a side of the plate A 2 in contact with the spacer by a couple-face tape.

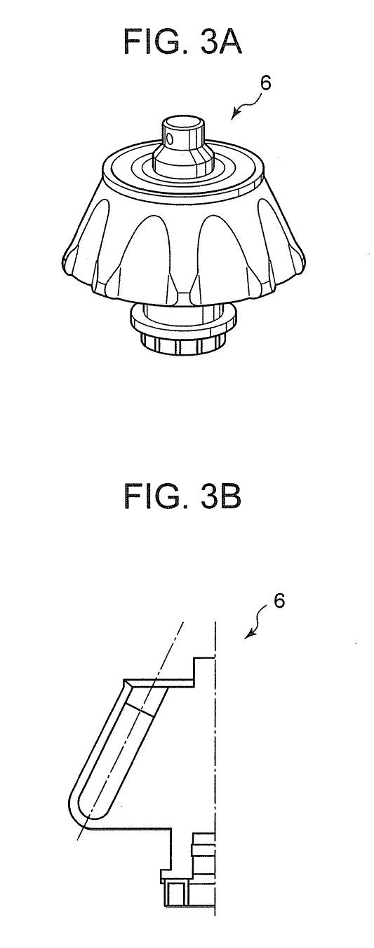

(3) As shown in FIG. 2, the sample set is attached in a cell 5. This cell 5 is attached in an angle rotor 6 shown in FIGS. 3A and 3B such that a rear side of a side of the plate A 2 on which a sample is stuck faces a rotation center. The angle rotor 6 is mounted on an ultracentrifuge (not shown).

(4) After rotating the ultracentrifuge at 10000 rpm, A and B are taken out and toner particles adhering to A and B are peeled off by a mending tape and stuck to white paper. Reflection density of the mending tape attached with the toner is measured by a Macbeth densitometer.

(5) A calibration expression for reflection density with respect to an amount of toner is separately prepared. An amount of toner separated and an amount of toner not separated are calculated in view of the calibration expression.

(6) The sheet attached with the toner is removed and stuck to the plate A in the same manner as (2) and attached in the ultracentrifuge in the same manner as (3). The ultracentrifuge is rotated at 20000 rpm and the plates A and B are taken out in the same manner as (4). Amounts of toner adhering to the plate A and the plate B are measured. Similarly, this is repeated every 10000 rpm until rotation of the ultracentrifuge reaches 100000 rpm.

(7) Centrifugal acceleration RCF applied to the sample set in the cell by the rotation of the rotor is calculated as described below.
RCF=1.118×10⁻⁵×r×N²×g
r: Distance from a rotation center of a sample set position
N: Rotation speed (rpm)
g: Gravitational acceleration
   A centrifugal force F applied to the toner particles is calculated as follows when weight of one toner particle is m.
   F=RCF×m
   m=(4/3)π×r³×ρ
r: Complete sphere equivalent radius
ρ: Specific gravity of a toner
   Thus, a sum of centrifugal forces F applied to the toner at respective numbers of revolutions multiplied by separated toner ratios at the respective numbers of revolutions is placed as an average adhesive force F (N) of the toner and the photosensitive member for the developing agent.

Similarly, in measurement of an adhesive force to a transfer medium, a toner is transferred onto a sheet of a material used for the transfer medium from a photosensitive member, the sheet attached with the toner is cut and stuck to the plate A. The toner is separated from the sheet with the ultracentrifuge. In this way, it is possible to measure an adhesive force of the toner and the transfer medium.

An amount of charges of the toner substantially affects the average adhesive force F (N) measured in this way. Thus, in order to accurately measure the average adhesive force F (N), it is desirable to create a measurement sample attached with the toner according to an actual process.

The average adhesive force of the toner particles to the medium is theoretically obtained by a sum of an electrostatic adhesive force and a non-electrostatic adhesive force. It is known that an actual measurement of the electrostatic adhesive force of the toner particles is five to ten times as large as a theoretical value of an electrostatic adhesive force of spherical particles generally used. For example, according to Journal of Imaging Science and Technology vol. 48, No. 5, 2004,
Fi=α·q²/4πε0D²
ε0: Dielectric constant of vacuum
α: Correction coefficient due to a difference of a dielectric constant between a photosensitive member and toner particles
q: Amount of charges of one toner particle
D: Particle diameter of toner particles
   A difference between an actual measurement and a theoretically value is considered. Similarly, in Japan Hardcopy 2005 B-13, consideration for theorizing an actual measurement is performed. However, a theory for clearly explaining a mechanism of occurrence of a difference between an actual measurement and a theoretical value has not been established.

Examples of factors include the facts that particulates with an object of improvement of fluidity or the like are externally added to surfaces of toner particles and particle diameters and shapes thereof are various, non-spherical particles ranging from undefined shaped particles to potato shaped and rugby ball shaped particles manufactured by the grinding method or the chemical process are generally used and spherical toner particles are not always used, and toner particles are formed of pigment, resin, a charge control agent, a lubricant, and the like and are not uniform particles.

In this way, it is conceivable that elements, which cannot be explained by existing physical property values such as a particle diameter and an amount of charges, affect an adhesive force characteristic. Thus, in order to control the adhesive force characteristic, the inventor calculated parameters described below from an actual measurement of an average adhesive force and found that these parameters actually affect the adhesive force characteristic.

K (N·kg²/C²) is an inclination as the average adhesive force F (N) is approximated to a linear function of a square of the amount of charges per weight of toner particles before transfer Q (μC/g). F₀ is a y intercept thereof (a value of F at the time of Q=0 in an approximation formula). K and F₀ are possibly obtained by, for example, varying a mix ratio of a toner and a carrier, plotting Q² on the x axis and plotting the average adhesive force F (N) on the y axis, and subjecting the average adhesive force F (N) to linear approximation.

In this case, it is desirable that the inclination K is in a range of 0<K≦3×10⁻⁵ (N·kg²/C²). When K is equal to or smaller than 3×10⁻⁵ (N·kg²/C²), an amount of change of an electrostatic adhesive force with respect to an amount of charges is small. Even if an amount of charges of a toner changes because of aged deterioration of a developing agent, fluctuation in a toner mixture ratio, fluctuation in environmental temperature and humidity, or the like, the change has little influence on an adhesive force of the toner and does not cause transfer failure easily. Since an electrostatic force increases depending on the amount of charges, K does not fall below 0.

It is desirable that the y intercept F₀ is in a range of 1.5×10⁻⁸<F₀<1×10⁻⁷ (N). If F₀ is smaller than 1.5×10⁻⁸ (N), an adhesive force of an uncharged toner to a photosensitive member decreases to cause scattering of toner particles that cannot be controlled by an electric field. On the other hand, if F₀ is larger than 1×10⁻⁷ (N), a deficiency occurs, for example, a necessary transfer electric field increases excessively or the development is less easily.

However, even if F₀ is increased to hold down movement of the toner particles that cannot be controlled by the electric field, it is possible to control an increase in the necessary transfer electric field even in highly-charged toner particles by reducing the inclination K. Thus, it is possible to attain both stability of high transfer efficiency and a transfer characteristic and high definition. An adhesive force, a particle diameter, and an amount of charges of toner particles are usually controlled according to average values. Thus, if particles having an adhesive force, a particle diameter, and an amount of charges substantially different from these average values are present, it is likely that the particles cause transfer residue or inverse transfer. Therefore, usually, a particle size distribution and an amount of charge distribution of toner are controlled to be narrow. However, it is possible to control the necessary transfer electric field by reducing the inclination K even when there are distribution in an adhesive force, a particle diameter, and an amount of charges of toner particles to some extent.

The A value obtained from these values indicates an adhesive force characteristic of the toner. When the A value is in a range of 1×10⁷≦A≦2.5×10⁷ (N/C), a satisfactory adhesive force characteristic is shown. When A is smaller than 1×10⁷, an adhesive force is too small and it is difficult to efficiently perform control by an electric field. Thus, the toner separates from a latent image portion of a photosensitive member in an area other than a transfer area or the toner scatters to a non-image portion on a transfer medium to deteriorate an image quality. On the other hand, when A exceeds 2.5×10⁷, since an adhesive force is too large, the toner requires a high transfer electric field to be peeled from a carrying medium, and discharge occurs in the transfer area to cause transfer failure to the contrary.

An image forming method according to an aspect of the invention is characterized by including a step of carrying and transferring toner particles containing a colorant and resin to a medium using an electrostatic force generated by an electric field E (V/m) and the electric field E is
1×10⁷≦E≦2.5×10⁷(V/m) and,
when an amount of charges before transfer per weight of the toner particles is Q (μC/g), an average adhesive force of the toner particles to the medium is F (N), a volume average particle diameter of the toner particles is d (μm), and a specific gravity of the toner particles is ρ (g/cm³), has a relation of
0.9≦E/A≦1.1
with respect to an A value represented by
A=(K×Q+F₀/Q)×6/ρπd³
K: an inclination at the time when F is approximated to a linear function of Q²
F₀: a y intercept at the time when F is approximated to a linear function of Q².

In this case, it is desirable to cause a force of an electric field of the same degree as the range of the A value indicating an adhesive force characteristic of the toner particles containing a colorant and resin and the medium to act using the electric field E to carry and transfer the toner to the medium. For example, in the case of a two-component developing agent, carrying media are a carrier, a photosensitive member, (an intermediate transfer medium), and a final transfer medium. A bias voltage is supplied to the respective medium to cause a force of an electric field in order to move the toner particles to respective transfer positions using chargers of the toner particles. In a primary transfer portion from the photosensitive member to the intermediate transfer medium, a resistance of the intermediate transfer medium, a magnitude of a transfer bias applied to the intermediate transfer medium, and the like are controlled such that an electric field appearing between a surface potential of the photosensitive member and a transfer bias is in range of 1×10⁷≦E≦2.5×10⁷ (V/m) and has a relation of 0.9≦E/A≦1.1 with respect to the A value. The same holds true when the intermediate transfer medium is not provided and the toner is directly transferred from the photosensitive member to the final transfer medium.

When the electric field E is set smaller than 1×10⁷ (V/m), it is impossible to secure a wide margin of the transfer media that fluctuates because of contamination of the carrying medium and a change in a carrying medium resistance due to environmental temperature and humidity. Therefore, a margin of an adhesive force characteristic of the toner also has to be narrow and strict. On the other hand, when the electric field E is set larger than 2.5×10⁷ (V/m), it is likely that the electric field exceeds a Paschen discharge limit in a non-image portion to cause image failure because of a discharge trace or the like.

It is possible to surely improve transfer efficiency by setting the electric field E to have a relation of 0.9≦E/A≦1.1 with respect to the A value. When E/A is smaller than 0.9, transfer insufficiency occurs. When E/A is larger than 1.1, charge injection into the toner occurs and an inversely charged toner remains as transfer residue.

In such an image forming method, an image is formed through, for example, a development process described below.

(Two-component Development Process)

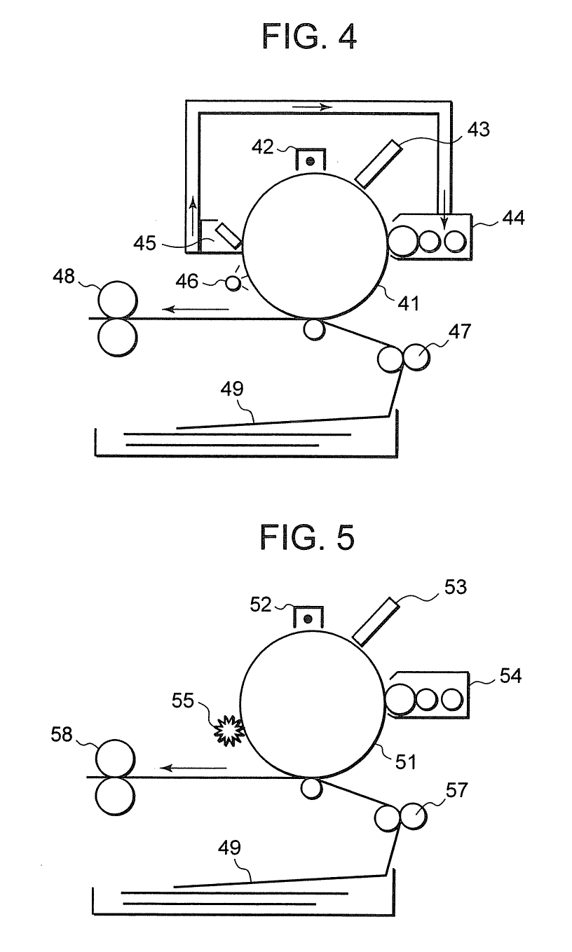

An image forming apparatus according to a two-component development process is shown in FIG. 4. As shown in the figure, an electrostatic latent image bearing member 41, a charging device 42 for charging the electrostatic latent image bearing member 41, an exposing device 43 for forming an electrostatic latent image, a developing device 44 for supplying toner particles to the electrostatic latent image, a cleaner 45 for removing a transfer residual toner, a charge eliminating lamp 46 for removing the electrostatic latent image, a sheet feeding device 47 that feeds paper serving as a final transfer medium, and a fixing device 48 for fixing a toner image on the paper are arranged. An image is formed on a transfer medium 49 according to steps described below using such an image forming apparatus.

(1) The electrostatic latent image bearing member 41 such as a belt or a roller is uniformly charged to a desired potential by the publicly-known charging device 42 such as a corona charger like a charge wire, a comb teeth shaped charger, or a scorotron, a contact charging roller, a non-contact charging roller, or a solid-state charger. A publicly-known photosensitive member such as a positively-charged or negatively-charged OPC (Organic Photoconductor) or amorphous silicon is used as the electrostatic latent image bearing member 41. In these photosensitive members, a charge generating layer, a charge transport layer, and a protective layer may be laminated or a layer having functions of plural layers among these layers may be formed.

(2) An electrostatic latent image is formed on the electrostatic latent image bearing member 41 by performing exposure using the exposing device 43 that uses publicly-known means such as a laser or an LED.

(3) In the developing device 44, a two-component developing agent consisting of a carrier and toner particles is stored in a hopper by a quantity of, for example, 100 g to 700 g. The developing agent is carried to a developing roller including a mug roller by an agitating auger. The charged toner particles are supplied to and attached on the electrostatic latent image on the electrostatic latent image bearing member 41 using a magnetic brush serving as a developing agent bearing member. Consequently, the electrostatic latent image is visualized and developed on the electrostatic latent image bearing member 41. In this case, DC or a development bias obtained by superimposing AD on DC may be applied to the developing roller in order to form an electric field for uniformly and stably attaching the toner particles.

The toner particles not used for the development are separated from the developing roller in a peeling pole position of the mug roller and collected in a developing agent storage by the agitating auger. A publicly-known toner density sensor is attached to the developing agent storage. When the density sensor detects a decrease in an amount of toner, a signal is sent to a toner supply hopper and a new toner is supplied. In this case, an amount of toner consumption may be estimated from integration of printing data or/and detection of an amount of development toner on the photosensitive member to supply the new toner on the basis of the estimated amount of toner consumption. In addition, means for estimating both a sensor output and an amount of consumption may be used.

(4) The toner image formed is transferred onto the transfer medium 49 such as paper through an intermediate transfer medium such as a belt or a roller or directly using publicly-known transfer means such as a transfer roller, a transfer blade, or a corona charger.

(5) The transfer medium 49 having the toner image transferred thereon is peeled from the intermediate transfer member or the electrostatic latent image bearing member 41, conveyed to the fixing unit 48, fixed by a publicly-known heating/pressing fixing system of a heat roller or the like, and discharged to the outside of the machine.

(6) After the toner image is transferred, a transfer residual toner not transferred and remaining on the electrostatic latent image bearing member 41 is removed by the cleaner 45. The electrostatic latent image on the electrostatic latent image bearing member 41 is erased by the charge eliminating lamp 46.

(7) The transfer residual toner removed by the cleaner 45 is stored in a waste toner box and, then, discharged through a conveyance path by the agitating auger or the like. In a recycle system, the transfer residual toner is collected in the developing agent storage of the developing device 44 from the conveyance path and reused.

(One-component Development Process)

In a one-component development process, an image is formed in the same manner by the same image forming apparatus as the two-component development process. However, a developing device portion is different. Only toner particles are stored in the developing device and developed without using a carrier.

The toner particles are supplied, by a publicly-known structure such as a carrying auger or an intermediate carrying sponge roller, to the surface of a developing agent bearing member such as an elastic roller having a conductive rubber layer on the surface thereof or a metal roller of SUS or the like provided with roughness on the surface thereof by sandblast or the like. The toner particles supplied to the surface of the developing agent bearing member are subjected to triboelectric charging by a toner charging member such as silicon rubber, a fluorine rubber, or a metal blade compression-bonded on the surface of the developing agent bearing member. The electrostatic latent image bearing member is opposed to be in contact with the developing agent bearing member or non-contact with the developing agent bearing member with a defined gap. The electrostatic latent image bearing member and the developing agent bearing member rotate with a speed difference, whereby the toner particles are developed. In this case, DC or a development bias obtained by superimposing AC on DC is applied to the developing roller in order to form an electric field for uniformly and stably attaching the toner particles.

(Cleanerless Process)

In a cleanerless process, an image is formed in the same manner by the same image forming apparatus as the two-component development process. However, as shown in FIG. 5, the cleanerless process is different from the two-component development process in that a cleaner is not provided. A transfer residual toner is collected simultaneously with development without using a cleaner.

As in the two-component development process, an electrostatic latent image bearing member 51 is charged and exposed, toner particles are attached on the electrostatic latent image bearing member 51 to be developed, and a toner image is transferred onto a transfer medium 59 via an intermediate transfer medium or directly. A transfer residual toner remaining in a non-image portion is kept remaining on the electrostatic latent image bearing member 51 and carried to a development area again through following steps of charge elimination, charging by a charging device 52, and exposure by an exposing device 53. The transfer residual toner is collected in a developing device 54 by a magnetic brush serving as a developing agent bearing member and developed anew.

In this case, before or after the charge eliminating step, a memory disturbing member 55 such as a fixed brush, felt, a rotating brush, or a lateral sliding brush may be arranged. It is also possible that a temporary collection member is arranged and the transfer residual toner is collected once, discharged onto the electrostatic latent image bearing member 51 again, and collected in the developing device 54. Moreover, a toner charging device may be arranged on the electrostatic latent image bearing member 51 in order to adjust an amount of charges of the transfer residual toner to a desired value. One member may carry out a part or all of the roles of the toner charging device, the memory disturbing member, the temporary collection member, and the charging device. A positive or negative voltage may be applied to these members in order to efficiently carry out the functions.

For example, tips of two lateral sliding brushes, which carry out all the three roles, are provided between the transfer area and the charging member of the electrostatic latent image bearing member 51 to be in contact with the electrostatic latent image bearing member 51. A voltage of the same polarity as development toner charges is applied to the brush on the upstream side and a voltage of the opposite polarity from the development toner charges is applied to the brush on the downstream side. Toner of the opposite polarity and a toner of the same polarity having extremely high charges are mixed in the transfer residual toner. The toner of the opposite polarity coming into contact with the brush of the same polarity slips through the brush with charges thereof reversed or is collected by the brush once. The transfer residual toner reaching the brush of the opposite polarity downstream from the brush of the same polarity has entirely the same polarity as the development toner. When the transfer residual toner comes into contact with the brush of the opposite polarity, since strong charges of the same polarity are relaxed, the transfer residual toner slips through the brush or is collected by the brush once. The transfer residual toner, which has been adjusted to a low amount of charges and has lost an image structure because of mechanical contact of the brush, is charged together with the electrostatic latent image bearing member 51 by the charging member of the electrostatic latent image bearing member 51 in a non-contact manner and adjusted to an amount of charges in just the same amount as the development toner. Consequently, in the development area, the transfer residual toner in a non-image portion in a new latent image is collected in the developing device 54. The transfer residual toner in an image portion is directly transferred to the transfer medium together with toner particles supplied from the developing device 54 anew.

(4-drum Tandem Process)

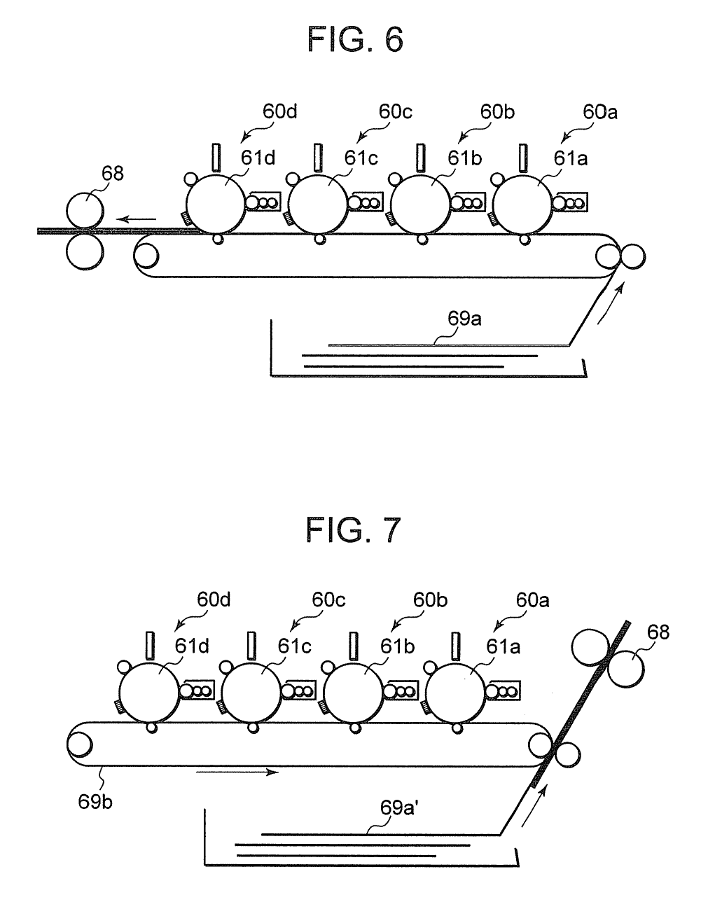

An image forming apparatus according to a 4-drum tandem process is shown in FIG. 6. As shown in the figure, image forming units 60a, 60b, 60c, and 60d for four colors including developing devices containing toner particles of colors, yellow, magenta, cyan, and black, respectively, electrostatic latent image bearing members, and charging, exposing, and developing devices are provided and arranged in parallel along a conveyance path for a transfer medium 69a. As in FIG. 4, a fixing device 68 for fixing a toner image on paper is arranged. An image is formed according to steps described below using such an image forming apparatus. In an example explained below, the colors are arranged in an order of yellow, magenta, cyan, and black.

(1) In the yellow image forming unit, a yellow toner image is formed on the electrostatic latent image bearing member 61a and transferred onto the transfer medium 69a. In the case of direct transfer, paper or the like serving as a final transfer medium is conveyed by a conveying member such as a transfer belt or a roller and supplied to a transfer area of the yellow image unit. A rubber material such as ethylene-propylene rubber (EPDM) or chlorobutadiene rubber (CR) or a resin material such as polyimide, polycarbonate, Polyvinylidene Difluoride (PVDF), or EthyleneTetrafluoro Ethylene (ETFE) is used for the transfer belt. A resin sheet may be formed in plural layers by attaching a lining of a rubber layer thereto. A rubber layer may be laminated on the transfer sheet. In this case, it is desirable that a volume resistance of the transfer belt is 10⁷ Ωcm to 10¹² Ωcm. As a transfer system, it is possible to use publicly-known transfer means such as a transfer roller, a transfer blade, or a corona charger.

As shown in FIG. 7, an intermediate transfer medium 69b may be provided. In this case, the intermediate transfer medium 69b of a belt shape or a roller shape is set to sequentially pass transfer areas of the respective image forming units 60a, 60b, 60c, and 60d. In the intermediate transfer belt, a material and a surface resistance thereof are the same as those of the transfer belt described above and a volume resistance thereof is set to, for example, 10⁹ Ωcm. Thin high-resistance layers may be provided on the surfaces of both the transfer belt and the intermediate transfer belt.

(2) In the magenta image forming unit 60b, similarly, a magenta toner image is formed on the electrostatic latent image bearing member 61b, the transfer medium 60a having a yellow toner image already transferred thereon is supplied to the transfer area of the magenta image forming unit 60b, and the magenta toner image is transferred from the top of the yellow toner image with a position of the magenta toner image adjusted to a position of the yellow toner image. In this case, the yellow toner on the transfer medium may be inversely transferred onto the magenta electrostatic latent image bearing member 61b depending on an amount of toner charges and intensity of a transfer electric field by coming into contact with the magenta electrostatic latent image bearing member 61b.

(3) In the cyan and black image forming units 60c and 60d, similarly, toner images are formed and sequentially transferred to be superimposed one on top of another on the transfer medium 69a. Similarly, the toner at the pre-stage may be inversely transferred onto the cyan and black electrostatic latent image bearing members 61c and 61d, respectively.

(4) The transfer medium 69a having the toners of the four colors superimposed thereon is peeled from the conveying member, conveyed to the fixing device 68 to have the toners fixed thereon by a publicly-known heating/pressing fixing system such as a heat roller, and discharged to the outside of the machine. When the intermediate transfer medium 69b is used, the toner images of the four colors are collectively transferred onto a final transfer medium 69a′ such as paper supplied by secondary transfer means. Thereafter, the final transfer medium 69a′ is conveyed to the fixing device 68 to have the toner images fixed thereon in the same manner and discharged to the outside of the machine.

In the respective image forming units, as in the two-component development process, the electrostatic latent image bearing members 61a, 61b, 61c, and 61d are subjected to charge elimination to have a transfer residual toner and an inversely transferred toner removed in a cleaning step and, then, return to the image formation process. In the developing device, a toner specific density is adjusted as in the two-component development process. In the example explained above, the image forming units are arranged in the order of colors, yellow, magenta, cyan, and black. However, the order of colors is not particularly limited.

(4-drum Tandem Cleanerless Process)

In a 4-drum tandem cleanerless process, an image is formed in the same manner by the same image forming apparatus as the 4-drum tandem process. Like the cleanerless process, the 4-drum tandem cleanerless process is different from the 4-drum tandem process in that a cleaner is not provided. A transfer residual toner and an inversely transferred toner are collected simultaneously with development without using a cleaner.

The invention will be hereinafter specifically explained with reference to an example.

In this example and a comparative example, a particle size distribution measuring device (BECKMAN COULTER COUNTER MULTISIZER 3) was used for measurement of an average particle diameter of toner particles.

A flow-type particle image analyzing device FPIA-3000 manufactured by Sysmex Corporation was used for measurement of roundness of the toner particles. When a peripheral length calculated from a projection area of particles and a diameter of an equal area equivalent complete round is D1 and a peripheral length of projected particles is D2, the roundness is calculated as roundness=D1/D2 (1 in the case of a complete round (=a complete sphere).

The image forming apparatus according to the two-component development process shown in FIG. 6 was used for measurement of transfer efficiency. An amount of un-transferred toner T2 on the photosensitive member after transfer to the transfer medium was measured with respect to an amount of toner development T1 on the photosensitive member (e.g., 300 μg/cm²) and transfer efficiency was calculated as transfer efficiency =T2/T1. In this case, an amount of toner on the photosensitive member is calculated by, for example, sucking a toner in a fixed area and measuring weight of the toner or measuring reflection density of a toner peeled by a tape and stuck to white paper with a Macbeth densitometer and calculating an amount of toner by applying the reflection density to a calibration expression of reflection density and an amount of toner prepared in advance.

First, toner particles were formed as described below.

(Formation of Toner Base Particles)

Toner base particles serving as materials for respective toner particles were formed. 28 parts by weight of polyester resin, 7 parts by weight of carmine 6B, 5 parts by weight of rice wax, and 1 part by weight of carnauba wax were kneaded by Kneadex manufactured by YPK to create a master batch. After rough grinding, 58 parts by weight of polyester resin and 1 parts by weight of CCA were added and kneaded. After rough grinding and fine grinding, particles with diameters equal to or larger than 8 μm and equal to or smaller than 3 μm were cut by elbojet classification to form toner base particles having an average particle diameter d=6.0 μm, a specific gravity ρ=1.2 g/cm³, and roundness of 0.92.

(Formation of Toner Particles a)

Suffusing processing was applied to the toner base particles formed to change a shape of the toner base particles to a potato shape with roundness of 0.94. 3 parts by weight of particulate silica with a particle diameter of 50 nm and 1.2 parts by weight of titanium oxide were mixed with 100 parts by weight of the toner base particles and externally added using a Henschel mixer to form toner particles a.

(Formation of Toner Particles b)

Suffusing processing was applied to the toner base particles formed to change a shape of the toner base particles to a potato shape with roundness of 0.94. 1.5 parts by weight of silica with a particle diameter of 70 nm, 1.5 parts by weight of particulate silica with a particle diameter of 20 nm, and 1 part by weight of titanium oxide were mixed with 100 parts by weight of the toner base particles and externally added using a Henschel mixer to form toner particles b.

(Formation of Toner Particles c)

Suffusing processing was applied to the toner base particles formed to change a shape of the toner base particles to a potato shape with roundness of 0.94. 1 part by weight of large-diameter silica with a particle diameter of 100 nm, 2 parts by weight of particulate silica with a particle diameter of 20 nm, and 0.7 parts by weight of titanium oxide were mixed with 100 parts by weight of the toner base particles and externally added using a Henschel mixer to form toner particles c.

(Formation of Toner Particles d)

The toner base particles formed were used as they were. 1.5 parts by weight of large-diameter silica with a particle diameter of 100 nm, 1.5 parts by weight of particulate silica with a particle diameter of 20 nm, and 0.3 parts by weight of titanium oxide were mixed with 100 parts by weight of the toner base particles and externally added using a Henschel mixer to form toner particles d.

(Formation of Toner Particles e)

Suffusing processing was applied to the toner base particles formed to change a shape of the toner base particles to a shape closer to complete sphere with roundness of 0.96. 1 parts by weight of large-diameter silica with a particle diameter of 100 nm, 2 parts by weight of particulate silica with a particle diameter of 20 nm, and 0.7 parts by weight of titanium oxide were mixed with 100 parts by weight of the toner base particles and externally added using a Henschel mixer to form toner particles e.

(Formation of Toner Particles f)

Suffusing processing was applied to the toner base particles formed to change a shape of the toner base particles to a shape of substantially complete sphere with roundness of 0.98. 1.5 parts by weight of large-diameter silica with a particle diameter of 100 nm, 1.5 parts by weight of particulate silica with a particle diameter of 20 nm, and 0.3 parts by weight of titanium oxide were mixed with 100 parts by weight of the toner base particles and externally added using a Henschel mixer to form toner particles f.

Developing agents were prepared from the toner particles formed and evaluation of the toner particles was performed.

(Preparation and Evaluation of a Developing Agent)

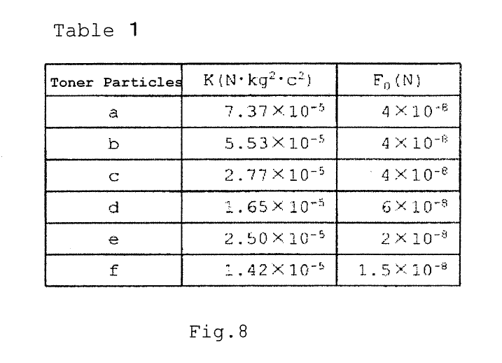

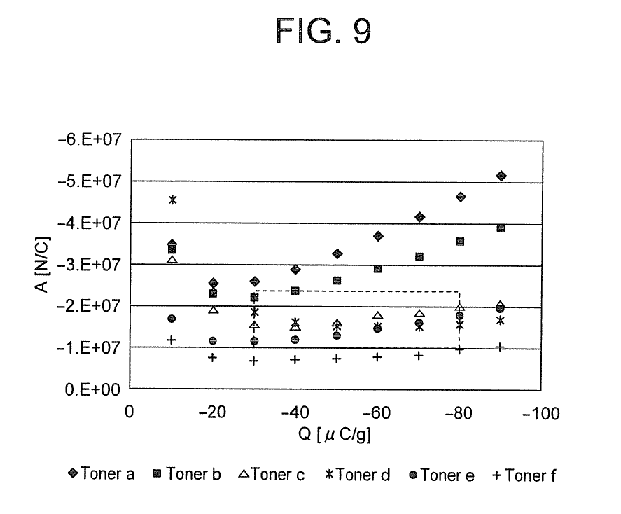

Carriers were added to the toner particles a to f formed to prepare developing agents with toner/carrier mixture ratios fluctuated. Average adhesive forces were measured using the developing agents prepared, respectively. Q2 was plotted on the x axis and an average adhesive force F (N) was plotted on the y axis and linear approximation was performed to calculate inclinations K and intercepts F₀ that were adhesive force characteristics of the toner particles a to f. The inclinations K and the intercepts F₀ of the respective toner particles are shown in Table 1 shown in FIG. 8. Moreover, A values were calculated from these values. A values corresponding to amounts of charges Q of the respective toner particles are shown in FIG. 9.

On the other hand, the developing agents obtained were actually inputted to the two-component development process, the cleanerless process, and the 4-drum tandem cleanerless process described above and images formed were evaluated.

(Evaluation Result of the Toner Particles a)

It is seen from FIG. 9 that the A value in the toner a is not within the range of 1×10⁷≦A≦2.5×10⁷ (N/C) even if the amount of charges is adjusted. In the toner a, although a developing agent adjusted to have an amount of charges of −30 μC/g was inputted to the two-component development process, transfer efficiency equal to or higher than 92% could not be obtained no matter how a transfer bias was adjusted. Under this condition, an amount of waste toner was extremely large and toner consumption efficiency was low. When the developing agent was inputted to the cleanerless process, exposure was hindered because of an influence of a transfer residual toner and negative image memory occurred.

(Evaluation Result of the Toner Particle b)

It is seen from FIG. 9 that the A value in the toner b is within the range of 1×10⁷≦A≦2.5×10⁷ (N/C) when an amount of charges is in a range of −15 to −45 μC/g but the A value deviates from this range when the amount of charges is larger than −45 μC/g. When a developing agent adjusted to have an amount of charges of −15 to −45 μC/g was inputted to the two-component development process, transfer efficiency was high and dust, insufficiency of density, and the like of the toner were not caused.

In the toner b, when a developing agent adjusted to have an amount of charges of −30 μC/g was inputted to the two-component development process, transfer efficiency of 95% was obtained. However, as shown in FIG. 8, since a value of K is high, when an amount of toner charges increases because of low temperature and low humidity environment, fluctuation in T/C, aged deterioration, or the like, the value of A deviates from the range and the magnitude of proper transfer electric field fluctuates. Therefore, high transfer efficiency could not be maintained, the transfer efficiency was deteriorated to 90%, and the amount of waste toner increased. In the cleanerless process, negative image memory occurred. Moreover, when the developing agent was inputted in the 4-drum tandem cleanerless process, since an amount of toner charges is low, inverse transfer often occurred and deterioration in definition of an image and color mixture occurred.

In the toner b, sufficient transfer efficiency was obtained by adjusting the developing agent to have an amount of charges of −30 μC/g and using the developing agent. However, under the low temperature and low humidity condition, the amount of toner charges increased, the A value increased, the transfer efficiency was deteriorated to 90%, and the amount of waste toner increased. In the cleanerless process, image memory occurred.

(Evaluation Result of the Toner Particle c)

It is seen from FIG. 9 that the A value in the toner c is within the range of 1×10⁷≦A≦2.5×10⁷ (N/C) when an amount of charges is in a range of −20 to −90 μC/g. In the toner c, when a developing agent was adjusted to have an amount of charges of −10 to −75 μC/g and inputted in the two-component development process in the same manner, transfer efficiency was high and dust, insufficiency of density, and the like of the toner were not caused. However, the transfer efficiency was high when an amount of charges was equal to or lower than −20 μC/g, toner scattering from the developing device, fog of a non-image portion, and the like occurred. In a range of −30 to −70 μC/g, such toner scattering, fog of the non-image portion, and the like were controlled.

When an amount of charges was set to −50 μC/g, transfer efficiency of 98% was obtained. Even when the developing agent was inputted in the cleanerless process, no problem occurred. A proper transfer bias did not substantially fluctuate because of environmental fluctuation and fluctuation with time. High transfer efficiency and high definition image were obtained stably. Moreover, when the developing agent was inputted in the 4-drum tandem cleanerless process, an amount of inverse transfer was small and the problems of deterioration in definition and color mixture did not occur.

When a developing agent was adjusted to have an amount of charges of −80 μC/g and inputted in the two-component development process in the same manner, deterioration in an amount of development and screen density was observed even if a charging potential, a development bias, and the like of an electrostatic latent image bearing member were adjusted.

The toner c was inputted to a direct transfer system process shown in FIG. 6. A transfer roller, a transfer belt, and paper serving as a transfer medium were stacked in a direct transfer area, an image portion potential on the surface of an electrostatic latent image bearing member was −50 V, a toner particle diameter was 6 μm, and a gap equivalent to one layer was present in a transfer unit. The transfer roller was obtained by covering a core metal with elastic and conductive rubber in thickness of 7 mm and a resistance thereof at the time of application of 1000 V was set to 10⁶Ω. The transfer belt was EPDM with thickness of 200 μm and a volume resistance thereof was set to 10⁹ Ωm. A bias voltage was applied to the core metal of the transfer roller according to constant current control at 10 μA. An amount of charges after development was −40 μC/g. When A at this point was calculated, A was 1.55×10⁷ (N/C). On the other hand, when intensity of an electric field between a paper surface and a photosensitive member surface was calculated, the intensity was 1.4×10⁷ (V/m). This was within a range of A±10% (N/C) and an extremely high value of 97% was obtained as transfer efficiency.

(Evaluation Result of the Toner Particles d)

It is seen from FIG. 9 that the A value in the toner d is within the range of 1×10⁷≦A≦2.5×10⁷ (N/C) when an amount of charges is in a range of −30 to −90 μC/g. In the toner d, when a developing agent was adjusted to have an amount of charges equal to or larger than −20 μC/g and inputted in the two-component development process in the same manner, transfer efficiency was high and dust, insufficiency of density, and the like of the toner were not caused. When an amount of charges of the toner d was set to −50 μC/g, regardless of the fact that roundness is low in a ground toner and F₀ is as large as 6×10⁻⁸, high transfer efficiency of 97%, stability of a transfer condition in environmental fluctuation and fluctuation with time, and a high definition image were obtained because a value of K was small. In the 4-drum tandem cleanerless process, an amount of inverse transfer was also small and deterioration in an image and color mixture did not occur.

When a developing agent was adjusted to have an amount of charges of −80 μC/g and inputted to the two-component development process in the same manner, transfer efficiency was high. However, since a development contrast potential had to be set extremely large in order to secure an amount of developed toners to a desired amount, photo-deterioration and ozone deterioration of an electrostatic latent image bearing member was fast. In a range of −30 μC/g or more and −80 μC/g or less, since a necessary transfer electric field was obtained at a low transfer bias, photo-deterioration and ozone deterioration did not occur and a satisfactory transfer characteristic and a high image quality were maintained.

(Evaluation Result of the Toner Particles e)

It is seen from FIG. 9 that the A value in the toner e is within the range of 1×10⁷≦A≦2.5×10⁷ (N/C) when an amount of charges is in a range of −10 to −90 μC/g. In the toner e, when a developing agent was adjusted to have an amount of charges equal to or smaller than −75 μC/g and inputted in the two-component development process in the same manner, transfer efficiency was high and dust, insufficiency of density, and the like of the toner were not caused. When an amount of charges of the toner e was set to −50 μC/g, transfer efficiency of 98% was obtained. Even when the developing agent was inputted in the cleanerless process, no problem occurred. A proper transfer bias did not substantially fluctuate because of environmental fluctuation and fluctuation with time. High transfer efficiency and a high definition image were obtained stably. Moreover, when the developing agent was inputted in the 4-drum tandem cleanerless process, an amount of inverse transfer was small and the problems of deterioration in definition and color mixture did not occur.

When a developing agent was adjusted to have an amount of charges of −80 μC/g and inputted in the two-component development process in the same manner, deterioration in an amount of development and screen density was observed even if a charging potential, a development bias, and the like of an electrostatic latent image bearing member were adjusted.

(Evaluation Result of the Toner Particles f)

It is seen from FIG. 9 that the A value in the toner f is within the range of 1×10⁷≦A≦2.5×10⁷ (N/C) when an amount of charges is in a range excluding −20 to −70 μC/g. In the toner f, when a developing agent was adjusted to have an amount of charges equal to or smaller than −50 μC/g and inputted in the two-component development process in the same manner, transfer dust of the toner was caused around an image regardless of the fact that the amount of charges was high. When the amount of charges was increased to −80 μC/g, no dust was caused. However, an amount of toner development could not be secured to a desired amount and image density was low.

As described above, it is possible to obtain a satisfactory adhesive force characteristic even in toner particles with a small particle diameter by setting the A value in the range of 1×10⁷≦A≦2.5×10⁷ (N/C). Moreover, it is possible to obtain a stable and satisfactory adhesive force characteristic with small aged deterioration by setting the amount of charges before transfer Q of the toner particles in the range of −80<Q≦−30 (μC/g) and setting the K value in the range of k≦3×10⁻⁵ (N·kg²/C²). It is possible to form a high-quality image by using a developing agent including toner particles having such an adhesive force characteristic, controlling the voltage E at the carrying and transfer time to be 1×10⁷≦E≦2.5×10⁷ (V/m), and controlling difference from the A value to be within ±10%. For example, when the cleanerless process is applied, it is possible to reduce a transfer residual amount to be extremely small and reduce an amount of toner temporarily collected by a brush for memory disturbance. Discharge of the toner from the brush is easy. It is possible to maintain the cleanerless process while keeping a high image quality for a long period of time. In the 4-drum tandem process, since it is also possible to control an amount of inverse transfer to be extremely small, it is possible to control color mixture.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A developing agent, comprising:
toner particles containing a colorant and resin, the toner particles carried and transferred to a medium using an electrostatic force generated by an electric field,
wherein an amount of charges before transfer per weight of the toner particles is Q (μC/g), an average adhesive force of the toner particles to the medium is F (N), a volume average particle diameter of the toner particles is d (μm), and a specific gravity of the toner particles is ρ (g/cm³), an A value represented by
A=(K×Q+F₀/Q)×6/ρπd³
K: an inclination at the time when F is approximated to a linear function of Q²
F₀: a y intercept at the time when F is approximated to a linear function of Q²
is in a range of
1×10⁷≦A≦2.5×10⁷(N/C).

2. The developing agent according to claim 1, wherein the amount of charges before transfer Q of the toner particles is in a range of
−80<Q≦−30(μC/g).

3. The developing agent according to claim 1, wherein a K value of the toner particles is in a range of
K≦3×10⁻⁵(N·kg²/C²).

4. The developing agent according to claim 1, wherein the volume average particle diameter d of the toner particles is in a range of
3≦d≦7(μm).

5. The developing agent according to claim 1, further comprising magnetic carrier particles.

6. The developing agent according to claim 1, wherein the medium is an electrostatic latent image bearing member.

7. The developing agent according to claim 1, wherein the medium is an intermediate transfer medium.

8. An image forming method, comprising:
carrying and transferring toner particles containing a colorant and resin to a medium using an electrostatic force generated by an electric field E (V/m),
wherein the electric field E is
1×10⁷≦E≦2.5×10⁷(V/m) and,
an amount of charges before transfer per weight of the toner particles is Q (μC/g), an average adhesive force of the toner particles to the medium is F (N), a volume average particle diameter of the toner particles is d (μm), and a specific gravity of the toner particles is ρ (g/cm³), has a relation of
0.9≦E/A≦1.1
with respect to an A value represented by
A=(K×Q+F₀/Q)×6/ρπd³
K: an inclination at the time when F is approximated to a linear function of Q²
F₀: a y intercept at the time when F is approximated to a linear function of Q².

9. The image forming method according to claim 8, wherein the amount of charges before transfer Q of the toner particles is in a range of
−80<Q≦−30(μC/g).

10. The image forming method according to claim 8, wherein a K value of the toner particles is in a range of
K≦3×10⁻⁵(N·kg²/C²).

11. The image forming method according to claim 8, wherein the volume average particle diameter d of the toner particles is in a range of
3≦d≦7(μm).

12. The developing agent according to claim 8, further comprising magnetic carrier particles.

13. The image forming method according to claim 8, further comprising collecting the toner particles on the medium electrostatically.

14. The image forming method according to claim 8, wherein carrying and transferring the toner particles to the medium is carrying and transferring different four kinds of toner particles to media corresponding to the respective kinds of toner particles sequentially.

15. The image forming method according to claim 14, further comprising collecting the toner particles on the respective media from the media electrostatically.

16. The image forming method according to claim 15, wherein the amount of charges before transfer Q of the toner particles is in a range of
−70<Q≦−40(μC/g).

17. The image forming method according to claim 8, wherein the medium is an electrostatic latent image bearing member.

18. The image forming method according to claim 8, wherein the medium is an intermediate transfer medium.
